(19) United States
(12) Patent Application Publication
(10) Pub. No.: US 2004/0252298 A1
(43) Pub. Date: Dec. 16, 2004

(54) Emulative particle contamination standard fabricated by particulate formation processes

(76) Inventors: Kenneth T. Luey, Culver City, CA (US); Gidget Kaye Ternet, Placentia, CA (US); Bruce H. Weiller, Santa Monica, CA (US)

Correspondence Address: The Aerospace Corporation, Ms. Carole A. Mulchinski, 2350 East El Segundo Boulevard, M1/040, El Segundo, CA, 90245, US

(21) Appl. No.: 10/460,876

(22) Filed: Jun. 12, 2003

(51) Int. Cl. G01J 1/10

(52) U.S. Cl. 356/243.1

(57) ABSTRACT

An emulative particle contamination standard is fabricated using photolithography and semiconductor processes to produce raised features, such as in a thick photoresist layer, to create stable and resilient raised structures that mimic realistic contamination, so as to enable the reproducible production of the emulative particle contamination standards that comprise the raised features of various sizes, shapes, and distribution across a highly reflective surface of an underlying substrate.

### STATEMENT OF GOVERNMENT INTEREST

The invention was made with Government support under contract No. F04701-00-C-0009 by the Department of the Air Force. The Government has certain rights in the invention.

### FIELD OF THE INVENTION

The invention relates to the field of particle contamination standards. More particularly, the invention relates to particle contamination standards using emulative particulates formed by photolithography, deposition, and etching fabrication-manufacturing processes.

### BACKGROUND OF THE INVENTION

Scientific and quantitative understanding is needed to predict and control the effects of contamination on systems, such as space systems. The performance and longevity of space telescopes, star trackers, thermal control systems, solar power arrays and mechanisms can be degraded by contamination. Contamination in the form of microscopic dust particles reduces light transmission in optical systems. Particles in fuels and lubricants can damage propulsion systems and mechanisms. Contaminants arise from ground processing environments, launch and ascent vibration, and outgassing of system materials. Contamination effects motivate the development of cleanliness measurement and verification methods. Contamination has been measured using visual inspections, airborne particle counting, and witness plates. Contamination levels cannot be precisely detected or verified. Contamination standards, such as the surface particle reference (SPR) or the absolute contamination standard (ACS) are used as a standard for the measurement of contamination levels. These contamination standards attempt to reflect realistic contamination for realistic inspections and are also used to calibrate contamination inspection instruments.

A contamination standard can be used to perform a sensitivity calibration of a surface inspection instrument. The sensitivity calibration method may include inspecting the standard for surface contamination at several different sensitivity levels. As the sensitivity of the instrument is increased, a particle map of the standard is displayed. As the sensitivity is increased the particle map will change. The instrument setting at which a quadrant of features appears, indicates the sensitivity level corresponding to the particle size value for that quadrant, with the exact size value being specified on the qualification report. A second method, the count data calibration method, can also be used to calibrate surface inspection instruments. Here, cumulative counters count all particles greater than or equal to a certain size. The count provides inflection points in a count graph indicating the instrument sensitivity levels, which correspond to the values on the qualification report. For instruments that display a size distribution in the form of a histogram, the scattering sites will appear as distinct peaks for each size. The mean value of each histogram peak is the instrument sensitivity level corresponding to that scattering site size. The sensitivity calibration method and the count data method are used to calibrate surface particle detectors, instruments that rely on the measurement of light scattered by the particles. Many factors other than particle size influence the scattering magnitude such as shape, orientation, and index of refraction of the particle. Additionally, the optical properties of the substrate can significantly affect the amount of light scattered. Hence, there is a need for highly reliable and accurate particle size and particle count contamination standards that can be recleaned for reuse and that reflect realistic contamination for meaningful contamination inspections and instrument calibrations.

The absolute contamination standard (ACS) is a clean silicon wafer with microscopic latex spheres deposited on the surface of a wafer comprising a substrate and surface mirror layer. The ACS is designed for particle size calibration of instruments that detect particles on the surface of silicon wafers. The ACS is prepared by placing neutralized polystyrene latex spheres on a silicon wafer. The spheres adhere to the substrate via weak Van der Waals forces. The latex spheres are highly spherical, have well-characterized optical properties, and very tight size distributions. These parameters make latex spheres a useful material for the calibration and monitoring of particle-counting instruments. The latex spheres are randomly distributed on the wafer surface such that the probability of two spheres being closer than 1.0 mm apart is less than 1%. Some ACS suppliers provide a guarantee that the number of multiplets, agglomerations of more than one sphere, will be less than 1% of the total population of spheres. The typical sphere diameters for current ACS are 0.060-4 μm, with custom sizes of up to 100 μm possible. Background contamination disadvantageously must be kept at an extremely low level and is defined by a ACS measurement certificate. These characteristics of the standard ensure a highly monodispersed population of spheres on the substrate.

The ACS is often used for instrument calibration to a particle size standard. Typically, the calibration methodology used to calibrate an instrument is to inspect the substrate for surface contamination at several different sensitivity levels. For instruments that display a size distribution, the latex sphere population will appear as a distinct peak in a histogram. The mean value of the peak is the instrument sensitivity level that corresponds to the latex sphere size. This process is usually repeated over a range of sizes. The absolute contamination standard is designed to calibrate particle size, not the particle count. The particle count value quoted on the measurement certificate is not a calibrated value as the measured count will disadvantageously vary due to edge exclusion, background contamination, and other factors.

All surface contamination detectors rely on measuring the amount of light scattered by a particle to determine particle size. Many factors other than particle size disadvantageously influence the scattering magnitude, such as shape, orientation, polarization state, and index of refraction of the particle. Additionally, the optical properties of the substrate can significantly affect the amount of light scattered. All parameters are well defined for the ACS, but disadvantageously preclude effects caused by other types of particles and substrates used. Except for the latex spheres, the ACS disadvantageously requires an extremely clean surface. Every additional particle on the surface of the ACS wafer diminishes the precision of the standard. For the longest possible life of the standard, many processing requirement rules must be followed, such as storing in class 10 environments, handling under a laminar flow hood, wearing of operator gowns and gloves, maintaining operating temperature ranges, and eliminating strong air flows. The latex spheres do adhere to the substrate strongly enough such that few if any will be removed due to shipping and proper handling. However, most semiconductor cleaning processes will remove the spheres. Therefore, ACS standards cannot be cleaned. That is, it is not possible to locally reclean or recertify an ACS due to deposition of particle contaminants onto the surface of the wafer. With strict background contamination requirements, the current ACS have disadvantageously short useful operational life times. The ACS disadvantageously includes the inability to specify the number of spheres placed on the surface (generally ±25% desired number), the inability to place spheres at specific locations on a wafer, and the relative weak sphere to surface adhesion forces that preclude cleaning.

For applications requiring particle count calibrations, a preferred method is the use of a surface particle reference (SPR) that has a known quantity of light scattering features etched into a wafer in a distinct pattern. These SPR are available for either Helium-Neon or Argon-Ion based machines and provides a recleanable monitor wafer that is also usable for contamination size-trend verification. In contrast to the ACS, the SPR is fabricated by etching features into a layer of silicon dioxide deposited on silicon substrate. The wells are used to emulate fixed sizes of contaminates. With this SPR, it is possible to specify the number and location of features that are etched by a subtractive process to create wells into the surface of the wafer. The wells are created by selective etching, typically through a photoresist mask. The photoresist masking processes has been patented as taught in U.S. Pat. No. 3,826,650, U.S. Pat. No. 4,058,401, U.S. Pat. No. 4,882,245, U.S. Pat. No. 5,026,624, U.S. Pat. No. 5,278,010, and U.S. Pat. No. 5,304,457. Further, U.S. Pat. No. 6,381,013 describes a glass test slide having trapped and calibrated surface debris for calibration of photon and electron microscopes standards for comparing image-forming capability of microscope imaging systems. Some semiconductor processes are used to form the surface debris. Like the ACS, the glass test slide cannot be cleaned for reliable repeated use.

The SPR is fabricated on a silicon wafer with the scattering sites formed in a layer of silicon dioxide. The wafer can be cleaned without damage provided the following criteria are met. The cleaning process cannot contain any step or chemical that will etch the silicon substrate. The cleaning process cannot contain any step or chemical that will etch the oxide. The wafer cannot be exposed to any high temperature that will facilitate growth of additional thermal oxide. As such, the SPR requires periodic requalification of the reference wafer. Although the SPR can be cleaned and then used again and again, it may be difficult to remove all unwanted contamination that lodges within the wells of the wafer surface. Because surface inspection systems rely on scattered light for feature sizing, a disadvantage of SPR is that light scattered from an etched feature is not the same as that scattered from an equivalent sized raised feature, such as a spherical particle on the surface of the wafer. Instead, when the SPR is used to calibrate surface inspection systems, light scattered from the etched pit and well features in the surface of the wafer is correlated to that scattered from polystyrene latex spheres of the ACS.

Specially designed scattering sites are precisely fabricated into the surface of a wafer of an SPR. These scattering sites are designed to optically represent the light scattering from small particles on the surface of a bare silicon wafer. Scattering sites or wells are arranged in a square, in rows and columns, for example, 6 sites each. The scattering sites are spaced apart, for example, at 2 mm apart, making the square, for example, 10 mm on a side. The square is divided into four quadrants with each quadrant containing a different size scattering site for representing a different size particle. The squares are arranged on the wafer, for example, in a checkerboard pattern. There are, for example, 108 scattering sites for each of the four sizes contained in 12 squares on a wafer, producing a total of 12×36=432 scattering sites. The blank areas are designed to allow monitoring of the unwanted contamination of the SPR that needs to be calibrated.

Quadrants of the SPR are calibrated directly to an ACS that contains latex spheres of a predetermined size. The magnitude of scattered light from each of the four quadrants on the SPR is compared to the latex spheres on the appropriate ACS. A calibration factor is computed for each quadrant indicating the ratio of light scattered from that site to the amount of light scattered by a latex sphere of a given diameter. For example, a qualification report may recite that a quadrant scattering site has a scattering magnitude of 92% of the amount of light scattered by a 1.112 micrometer diameter latex sphere, indicating that the scattering sites in the quadrant scatter 0.92 times as much light as a latex sphere 1.112 micrometer in diameter on a bare silicon wafer. The specific scattering magnitudes are measured for each reference, for example, on a Helium-Neon scattering measuring system and recorded on the qualification report.

The existing ACS provides a particle size standard comprising weakly bound spherical particles and is not cleanable for repeated use. The ACS has wide and variable particle count distributions rendering the standard imprecise for particle count calibrations. The existing SPR use etched square wells that do have precise sizes and particle counts, but cannot be easily cleaned for repeated use. In both cases, the spheres and wells do not accurately reflect various types of contaminates, rendering the standards at best an approximation to real contamination, and the calibrations of instruments to realistic contamination standards. Also, existing photoresist processes in the photolithographic production of existing contamination standards are unsuitable for making fine features that represent realistic contaminant particles. Existing standards cannot be cleaned, adjusted, cannot be reproducibly manufactured, and do not provide realistic particles in size, size distribution, or shape. These and other disadvantages are solved or reduced using the invention.

### SUMMARY OF THE INVENTION

An object of the invention is to provide a method of fabricating a particle count and particle size contamination standard.

Another object of the invention is to provide a method of fabricating a particle count and particle size contamination standard that can be cleaned for repeated use.

Yet another object of the invention is to provide a method of fabricating a particle count and particle size contamination standard that reflects realistic contamination particles.

Still another object of the invention is to provide a method of precisely fabricating a particle count and particle size contamination standard that reflects realistic contamination particles using conventional photolithographic and semiconductor processes.

The invention is directed toward a method for fabricating an emulative particle standard having positive emulative particles that emulate realistic contamination. The emulative particle standard can be used to evaluate the accuracy and precision of various cleanliness-measurement techniques including optical scattering, electron microscopy, image analysis, and semiconductor surface flaw detectors. The emulative particle contamination standard will act as a permanent stable representation of small levels of particulate contamination. The emulative particle contamination standard can be fabricated using a variety of processes to create a distribution of particles. The reproducible emulative particle contamination standards are made for use to calibrate particle inspection systems for particle size or particle count.

The emulative particle contamination standards are fabricated using a variety of methods, such as photolithography and semiconductor processing methods, to produce raised features that emulate realistic contamination. In one form of the invention, a thick photoresist layer that can be cross-linked is used to create stable and resilient structures in an etchant layer. This method is characterized by a thick negative photoresist layer used in combination with a dark field mask to produce precise reproducible raised features that mimic realistic contaminants. The dark field mask avoids process problems associated with contamination of the bright field masks that produce undesirable residual features in the photoresist etchant layer, so that, the etchant layer provides only the desired emulative contamination features.

The emulative particle contamination standards can be fabricated using many different deposition and etching fabrication processes. These methods facilitate rapid and reproducible production of standards that comprise features of various dimensions and thickness. The emulative particle contamination standards can comply with cleanliness requirements for future space programs. An array of contamination features that represent the particulate contamination size distribution specified is created on a wafer substrate, such as a bulk silicon substrate. The method is capable of producing a contamination standard with any number of features of specified sizes, specified shapes, and specified distribution over the substrate. The methods provide a reproducible standard with an optical surface having a verifiable number of contaminant features and a selectable size range between 0.1 μm to 2000 μm. The emulative particle contamination raised features have predetermined sizes, shapes, and distribution that mimic realistic contamination profiles, as well as being stable and permanent to enable repeated cleaning for reuse. These and other advantages will become more apparent from the following detailed description of the preferred embodiment.

### BRIEF DESCRIPTION OF THE DRAWINGS

FIG. 1A is a drawing of an emulative particle standard.

FIG. 1B is a flow diagram of a dark field fabrication process.

FIG. 2A is a flow diagram of an emulative particle standard masked etching fabrication process.

FIG. 2B is a flow diagram of an emulative particle standard particle beam etching fabrication process.

FIG. 3A is a flow diagram of an emulative particle standard shadow mask deposition fabrication process.

FIG. 3B is a flow diagram of an emulative particle standard liftoff masked deposition fabrication process.

FIG. 3C is a flow diagram of an emulative particle standard beam deposition fabrication process.

FIG. 3D is a flow diagram of an emulative particle standard laser beam deposition fabrication process.

### DETAILED DESCRIPTION OF THE PREFERRED EMBODIMENT

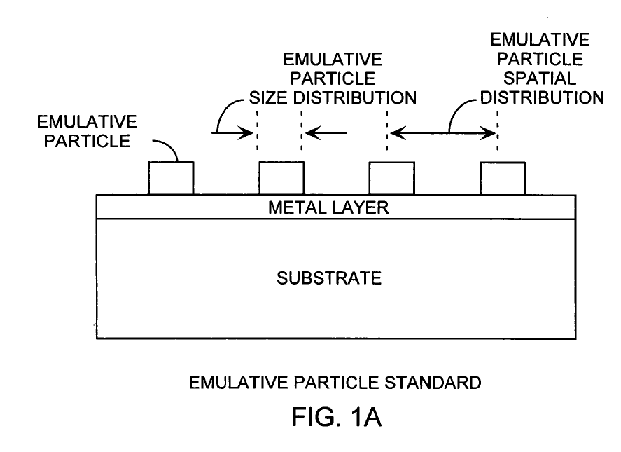

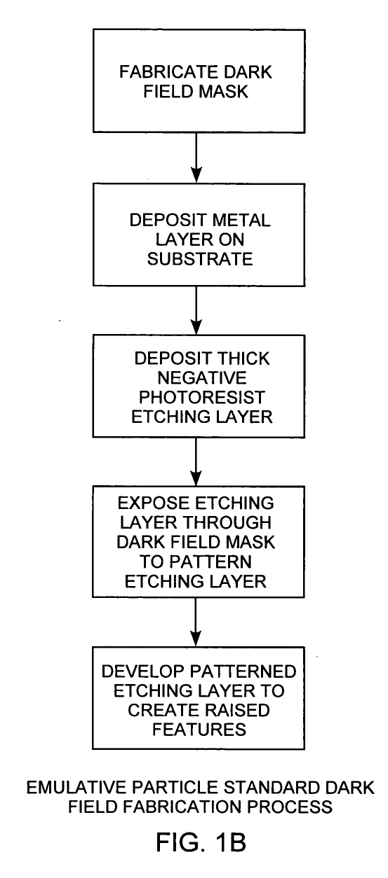

An embodiment of the invention is described with reference to the figures using reference designations as shown in the figures. Referring to FIG. 1A, an emulative particle contamination standard is shown including a plurality of emulative particles upon a substrate. The emulative particles are raised features upon an underlying substrate. The emulative particles are shown as simple cubes for representing realistic crystalline contaminates, but the emulative particles could be made in a variety of different shapes for emulatively mimicking a respective plurality of realistic shapes. The shapes may include cones, cylinders, pyramids and irregular polygonal volumes to emulate dust, crystalline dirt, salt crystals, and general processing debris. Straight, curved or zigzagging linear particles may be used to emulate cotton fibers, threads, lint and hair, and synthetic fibers such as nylon or polyester. Hemispheres may be used for emulating pollen, spores, and plant debris. Crescents may be used to emulate paint, metal and skin flakes, spheres for emulating spherical particulates, jagged clumps for emulating biological particulates, any form of irregular shape for emulating generalized dirt or contamination particulates, or any idealized shape for emulating idealized contamination for testing optical properties of the emulative particulate standard.

As may now be apparent, any number and types of emulative particles can be deposited upon the reflective substrate. That is, the numerical count distribution, size distribution, shape distribution, and spatial distribution of the emulative particles about the substrate can vary as desired and be predetermined by a suitable fabrication process for fabricating reproducible productions of the emulative particle standard (EPS). The substrate preferably has a highly reflective surface, which may be a metal layer, as shown. The metal layer can be made of aluminum, gold, silver, or other reflective materials or highly polished materials. For example, the reflective surface can be a polished surface of a bulk silicon substrate. The substrate can be a made of bulk crystalline silicon, germanium, gallium arsinide, sapphire, aluminum oxide, ceramics, borosilicate glass, metal, steel, or other suitable material that is well suited for providing a uniform optical scattering surface that is highly reflective, supports the raised emulative particles, and can be cleaned many times for operational reuse of the emulative particle standard. For convenience, the emulative particles are shown as simple square blocks, but the emulative particles can take on any desire raised form, distribution, and count. A top layer shown to be a metal acts to provide consistent optical back scattering across the reflective surface of the EPS. The EPS can be made using a variety of fabrication methods.

Referring to FIGS. 1A and 1B, in a preferred form of the invention, the emulative particle standard can be made using a dark field mask fabrication process. A dark field mask is firstly fabricated and a thick negative photoresist is deposited on the substrate. The negative photoresist is exposed to pattern the photoresist, which is considered to be an etching layer that is etched leaving the raised features. That is, the exposed area of the photoresist etching layer are areas where emulative particles will be formed. The photoresist is then developed to etch patterned photoresist resulting in the fabrication of the emulative particles. Because the dark field mask can be used over and over, the dark field mask fabrication creates reproducible identical emulative particle standards with raised features that can be of high aspect-ratio. The dark field mask has bright areas for emulative particle formation, and as such, is preferably dominated by dark areas where process contamination upon the dark field mask will not-create undesired raised features upon the substrate during fabrication. In the preferred form, a negative photo mask can be used to create a high density of raised features of different sizes, for example, four different sizes, along with register marks, not shown, and as desired, to facilitate feature location or measurement orientation. As such, the EPS can be fabricated using photolithography batch processes to produce raised features from thick photoresist layers. This dark field mask fabrication method will facilitate rapid and reproducible production of emulative particle contamination standards of various features, dimensions, and thickness. The dark field photomask and negative photoresist are used to provide reproducible EPSs. A SU-8 negative photoresist, for example, can be deposited in a 5.0 micron to 50.0 micron thick layer to create features with high aspect ratios, such as 20:1, deposited on a silicon wafer. The raised features can be characterized by optical microscopy, scanning electron microscopy, and profilometry. The emulative particles may be seen with the naked eye using scattered light. The emulative particles can be characterized using a commercial surface inspection system. Using negative photo mask fabrication process, a number of EPSs can be fabricated for characterization with various types of surface inspection systems.

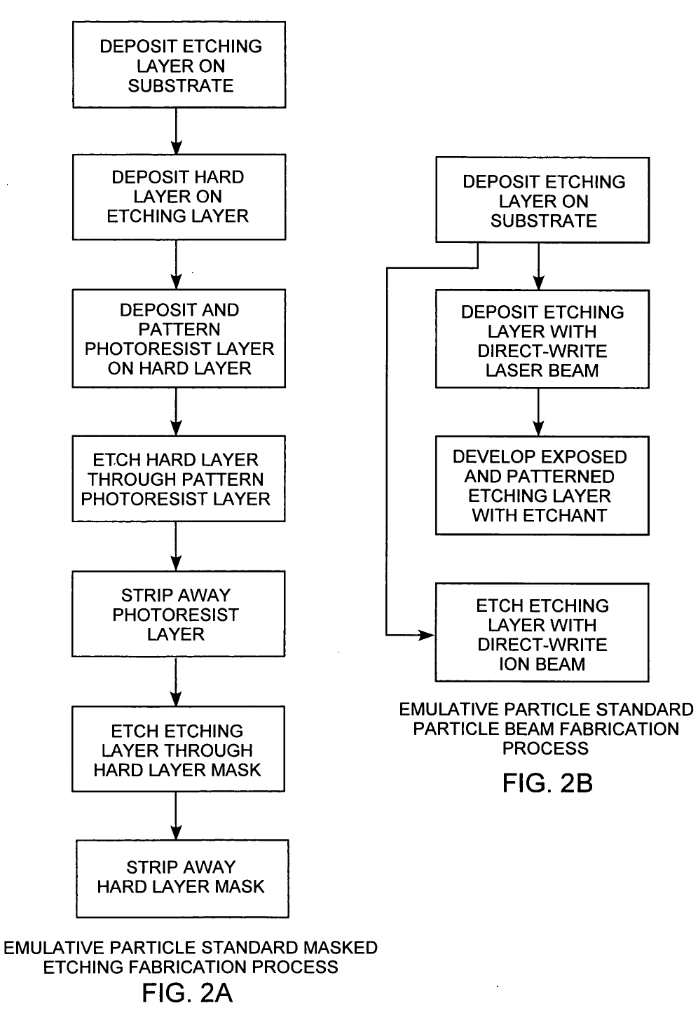

As may now be apparent, the emulative particle standard, can be fabricated using a variety of different batch processing fabrication methods, including etching fabrication methods. Referring to FIGS. 2A, a masked etching fabrication process can be used to form the EPS. The etching layer is deposited on the substrate. A hard layer is deposited on the etching layer. The hard layer can be, for example, silicon nitride. A photoresist layer is deposited on the etching layer and then patterned by photolithography. The photoresist is developed leaving wells in the photoresist layer for selectively etching and patterning the hard layer into a hard layer mask. The photoresist is stripped away and an etchant is applied over the hard mask layer for pattern etching of the etching layer. The hard mask layer is stripped away, leaving the patterned etching layer of raised features. Referring to FIG. 2B, an EPS particle beam etching fabrication process also deposits the etching layer on the substrate. In one form, the etching layer is etched with a direct-write ion beam to ablate the substrate for creating the raised features. In another form, the etching layer is exposed by a direct-write laser beam for creating an exposed etching layer that is then etched by an etchant to create the raised features in the etching layer.

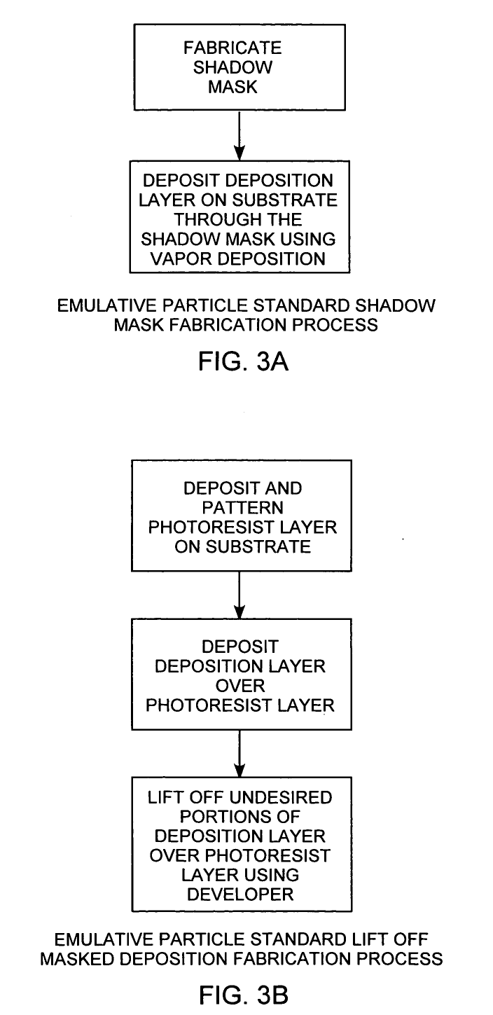

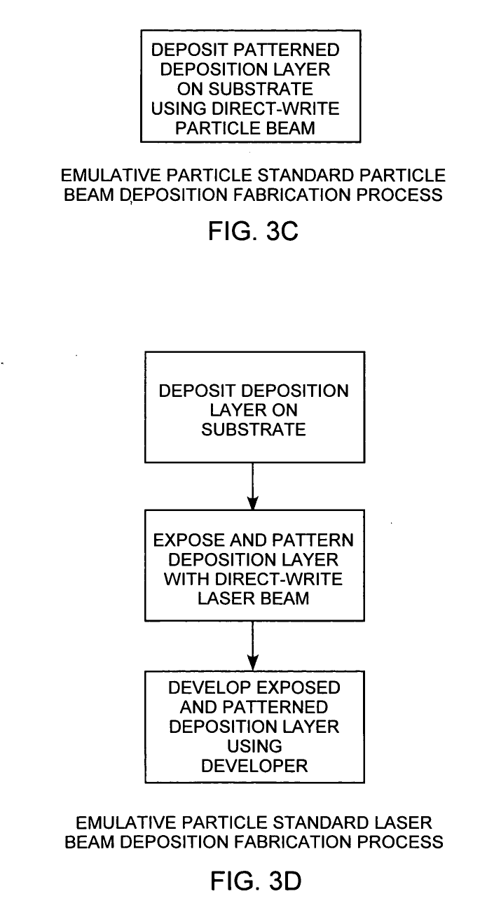

As may now be also apparent, the emulative particle standard can be fabricated using a variety of different batch processing fabrication methods, including deposition fabrication methods wherein the raised features are created in a deposition layer. Referring to FIG. 3A, an EPS shadow mask deposition fabrication process uses a shadow mask that is firstly created. A patterned deposition layer is created by depositing the deposition layer on the substrate through the shadow mask using vapor deposition. Referring to FIG. 3B, an EPS liftoff masked deposition fabrication process uses a photoresist layer that is deposited and patterned over the substrate. A deposition layer is deposited over the photoresist layer. Liftoff portions of the deposition layer over surviving portions of the photoresist layer and the photoresist layers using a developer. Referring to FIG. 3C, an EPS particle beam deposition fabrication processes uses a patterned deposition layer that is deposited on the substrate using a direct-write particle beam. Referring to FIG. 3D, an EPS laser beam deposition fabrication process deposits a deposition layer on the substrate. The deposition layer is exposed and patterned using a direct-write laser beam. The exposed and patterned depositing layer is developed using a developer. As may now be apparent, the etching and deposition processes are conventional processes.

The invention is directed to an emulative particle standard that can be reliably reproduced, and cleaned for reuse, in a variety of configurations for intended use as a contamination standard. For example, the standard can be used to represent cleanliness requirements for future space programs, such as for the IEST-CC-1246, Level 100. The array of raised features that represent the particulate contamination size distribution specified in IEST-CC-1246 can be created on a silicon wafer. The emulative particle standard is fabricated using conventional processing methods capable of producing emulative particles of small raised features of specified sizes, specified shapes, specific numerical count, and specified spatial distribution about the substrate, using a large variety of differing materials. Those skilled in the art can make enhancements, improvements, and modifications to the invention, and these enhancements, improvements, and modifications may nonetheless fall within the spirit and scope of the following claims.

What is claimed is:

1. A standard for emulating predetermined particle contamination, the standard comprising,
a substrate for providing a reflective surface, and
a plurality of raised features extending from the reflective surface for emulating the predetermined particle contamination.

2. The standard of claim 1 further comprising,
a metal layer deposited on the substrate, the raised features being deposited on the metal layer, the metal layer providing the reflective surface.

3. The standard of claim 1 wherein,
the substrate is a polished wafer.

4. The standard of claim 1 wherein,
the raised features are formed on the substrate using photolithography processes.

5. The standard of claim 1 wherein,
the raised features are formed by a fabrication process comprising the steps of,
fabricating a dark field mask having bright areas for defining the raised features and dark areas for defining the reflective surface,
depositing a negative photoresist over the substrate,
exposing the negative photoresist with light radiation through dark field mask,
developing the negative photoresist for removing unexposed portions of the photoresist, unremoved exposed portions of the photoresist forming the raised features.

6. The standard of claim 1 wherein,
the raised features are formed by a fabrication process comprising the steps of, fabricating a dark field mask having bright areas for defining the raised features and dark areas for defining the reflective surface,
depositing a metal layer over the substrate for providing the reflective surface,
depositing a negative photoresist over the metal layer,
exposing the negative photoresist with light radiation through the dark field mask, and
developing the negative photoresist for removing unexposed portions of the photoresist, unremoved exposed portions of the photoresist forming the raised features.

7. The standard of claim 1 wherein the raised features are formed in an etching layer by depositing the etching layer and etching the etching layer using etching fabrication processes.

8. The standard of claim 1 wherein, the raised features are formed in an etching layer and etched using a photolithography process comprising the steps of,
depositing the etching layer over the substrate,
depositing a hard layer over the etching layer,
depositing and patterning a photoresist layer over the hard layer,
etching the hard layer through the photoresist layer for forming a hard layer mask, and
etching the etching layer through the hard layer mask, and
removing the hard layer mask.

9. The standard of claim 1 wherein, the raised features are formed in a deposition layer and etched using a direct-write fabrication process comprising the steps of,
depositing the etching layer over the substrate, and
direct-write patterning the etching layer.

10. The standard of claim 1 wherein, the raised features are formed in a deposition layer and etched using a direct-write fabrication process comprising the steps of,
depositing the etching layer over the substrate,
direct-write pattern exposing the etching layer, and
developing the etching layer to etch the etching layer.

11. The standard of claim 1 wherein the raised features are formed by depositing a deposition layer through a shadow mask using a vapor deposition fabrication process comprising the steps of,
forming the shadow the mask, and
depositing the deposition layer in a pattern on the substrate by vapor deposition through the shadow mask.

12. The standard of claim 1 wherein the raised features are formed by depositing a deposition layer using a photolithography liftoff fabrication process comprising the steps of,
depositing a photoresist layer over the substrate,
patterning the photoresist layer for exposing portions of the substrate,
depositing the deposition layer over the exposed portions of the substrate and over surviving portions of the photoresist layer, and
stripping off the surviving portions of the photoresist layer for lifting off portions of the deposition layer deposited over the surviving portions of the photoresist layer.

13. The standard of claim 1 wherein the raised features are formed by depositing a deposition layer using a particle beam deposition fabrication process comprising the steps of,
direct-writing the deposition layer in a pattern on the substrate.

14. The standard of claim 1 wherein the raised features are formed by depositing a deposition layer using a laser beam fabrication process comprising the steps of,
depositing the deposition layer on the substrate,
exposing the deposition layer in a pattern using a direct-write laser beam, and
developing the deposition layer.

15. The standard of claim 1 wherein the standard is reproducible by a fabrication process.

16. The standard of claim 1 wherein the standard can be repetitively cleaned by a cleaning process.
